(19) United States
(12) Patent Application Publication
(10) Pub. No.: US 2016/0232281 A1
(43) Pub. Date: Aug. 11, 2016

(54) High-order sequence kernel methods for peptide analysis

(71) Applicant: NEC Laboratories America, Inc., Princeton, NJ (US)

(72) Inventors: Renqiang Min, Princeton, NJ (US); Pavel Kuksa, Philadelphia, PA (US)

(21) Appl. No.: 14/511,495

(22) Filed: Oct. 10, 2014

Related U.S. Application Data
(60) Provisional application No. 61/969,928, filed on Mar. 25, 2014.

(51) Int. Cl. G06F 19/18; G06N 5/04; G06F 19/24; G06F 19/22

(52) U.S. Cl. CPC G06F 19/18; G06F 19/22; G06N 5/047; G06N 5/048; G06F 19/24

(57) ABSTRACT

System and methods are disclosed to perform peptide-MHC interaction prediction by applying a high-order kernel function to determine a similarity between peptide sequences; applying one or more supervised strategies to the kernel to encode relevant physicochemical and interaction information about peptide sequence and MHC molecule; and applying a classifier to the kernel to identify the peptide-MHC interaction of interest in response to a query.

This application claims priority to Provisional Application 61/969,928 filed Mar. 25, 2014, the content of which is incorporated by reference.

### BACKGROUND

Complex biological functions in living cells are often performed through different types of protein-protein interactions. An important class of protein-protein interactions are peptide (i.e. short chains of amino acids) mediated interactions, and they regulate important biological processes such as protein localization, endocytosis, post-translational modifications, signaling pathways, and immune responses etc. Moreover, peptide-mediated interactions play important roles in the development of several human diseases including cancer and viral infections. Due to the high medical value of peptide-protein interactions, a lot of research has been done to identify ideal peptides for therapeutic and cosmetic purposes, which renders in silico peptide-protein binding prediction by computational methods a highly important problem in immunomics and bioinformatics. In this paper, we propose novel machine learning methods to study a specific type of peptide-protein interaction, that is, the interaction between peptides and Major Histocompatibility Complex class I (MHC I) proteins, although our methods can be readily applicable to other types of peptide-protein interactions. Peptide-MHC I protein interactions are essential in cell-mediated immunity, regulation of immune responses, vaccine design, and transplant rejection. Therefore, effective computational methods for peptide-MHC I binding prediction will significantly reduce cost and time in clinical peptide vaccine search and design.

Previous computational approaches to predicting peptide-MHC interactions are mainly based on linear or bi-linear models, and they fail to capture non-linear high-order dependencies between different peptide amino acid positions. Although previous Kernel SVM and Neural Network (NetMHC) approaches can capture nonlinear interactions between input features, they fail to model the direct strong high-order interactions between features. As a result, the quality of the peptide rankings produced by previous methods is not good enough. Producing high-quality rankings of peptide vaccine candidates is essential to the successful deployment of computational methods for vaccine design, for which modeling direct non-linear high-order feature interactions between different amino acid positions becomes very important.

### SUMMARY

A system modeling high-order feature interactions uses high-order Kernel Support Vector Machines to efficiently predict peptide-Major Histocompatibility Complex (MHC) binding.

Advantages of the above system may include one or more of the following. The peptide-MHC binding prediction methods improve quality of binding predictions over other prediction methods. With the methods, a significant gain of 10-25% is observed on benchmark and reference peptide data sets and tasks. The prediction methods allow integration of both qualitative (i.e., binding/non-binding/eluted) and quantitative (experimental measurements of binding affinity) peptide-MHC binding data to enlarge the set of reference peptides and enhance predictive ability of the method, whereas the existing methods (e.g., NetMHC) are limited to only less widespread quantitative binding data. As the instant methods are based on the analysis of sequences of known binders and non-binders, the predictive performance will continue to improve with accumulation of the experimentally verified binding/non-binding peptides. This ability to accommodate and scale with increasing amounts of data is critical for further refinement of the prediction ability of the method.

### BRIEF DESCRIPTION OF THE DRAWINGS

FIG. 1 shows an exemplary system for peptide-MHC binding recognition.

FIG. 2 shows an exemplary peptide prediction method.

FIG. 3 shows an exemplary peptide descriptor sequence representation.

FIG. 4A-4C shows additional exemplary peptide matrix representations.

FIG. 5 shows the placement of the computational method in the machine learning pipeline for training and prediction.

### DESCRIPTION

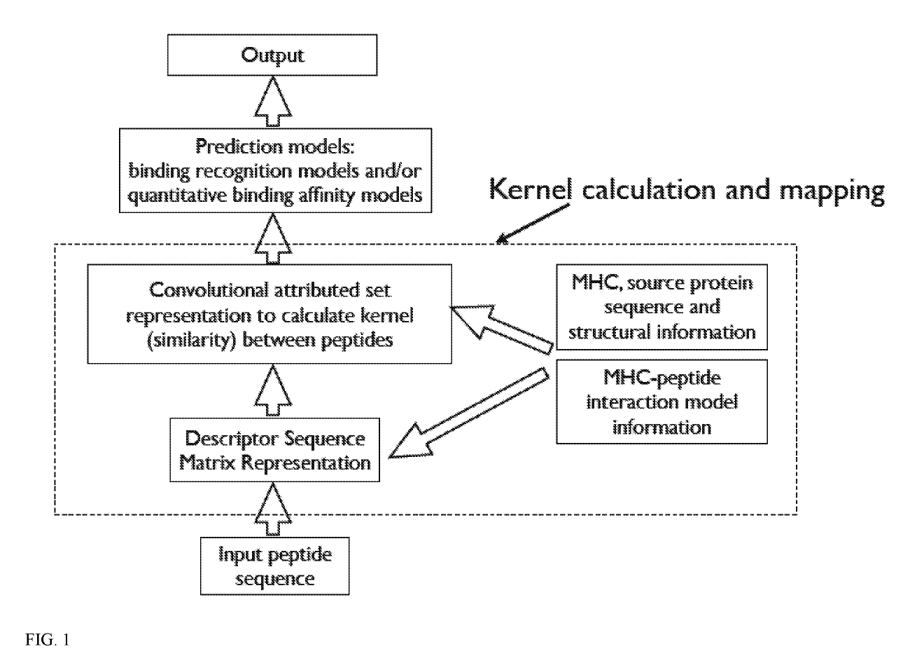

An exemplary system containing the proposed kernel or similarity computation unit is shown in FIG. 1. The system receives an input peptide sequence and performs kernel calculation and mapping. In one embodiment, the system generates a descriptor sequence matrix representation of the input peptide sequence; applies a convolutional attributed set representation to determine a kernel between peptides, wherein the kernel considers a similarity of individual amino acids or string of amino acids and a similarity of a context including location or coordinate, or a set of neighboring amino acids, or peptide-MHC amino acid contact residues to compute the degree-of-similarity value between peptides. Once the kernel calculation and mapping operations are done, the system applies one or more prediction models including binding models or quantitative binding affinity models to determine peptide-MHC binding recognition and generates an output.

In implementations, the operations include applying an MHC-peptide interaction model to the matrix representation. The system can apply MHC, source protein sequence, and structural information. The system designed kernel functions are applied to peptides during training to estimate a set of predictor parameters, and wherein the kernel functions compute the prediction values for unlabeled peptides. The kernel functions determine similarity between peptides using descriptor sequence representation of the peptides. The kernel contains specialized kernel functions including position-set, context, and property kernel functions for peptide binding and T-cell epitope prediction.

The nonlinear high-order machine learning method uses High-Order Kernel SVM for peptide-MHC I protein binding prediction. Experimental results on both public and private evaluation datasets according to both binary and non-binary performance metrics (AUC and nDCG) clearly demonstrate the advantages of our method over the state-of-the-art approach NetMHC, which suggests the importance of modeling nonlinear high-order feature interactions across different amino acid positions of peptides.

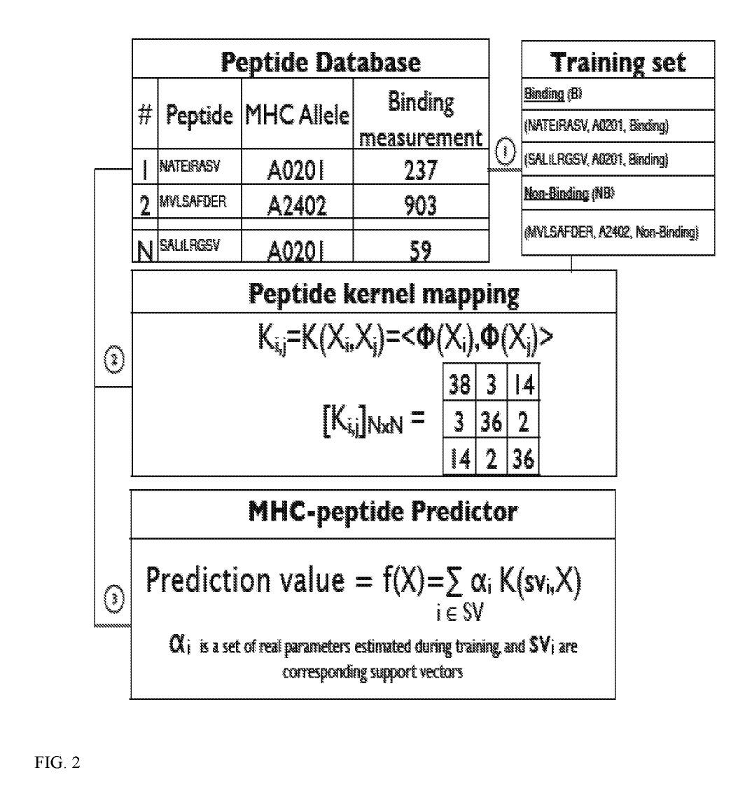

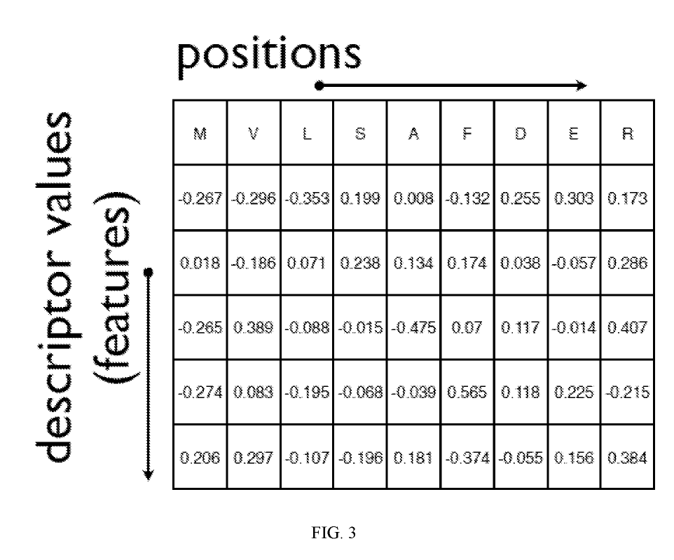

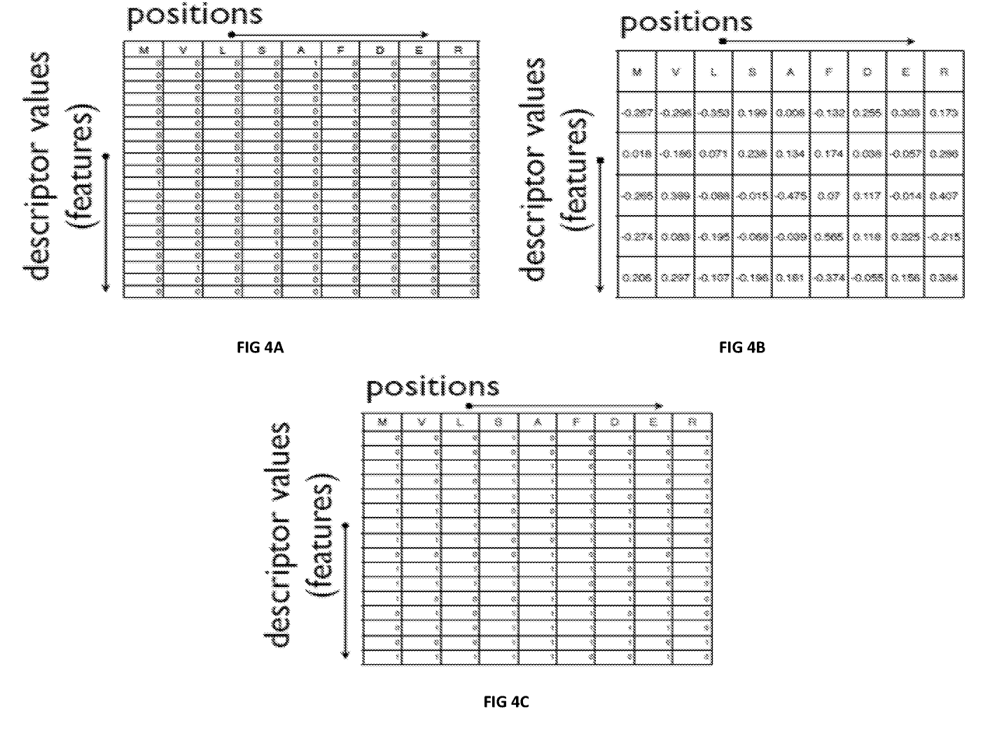

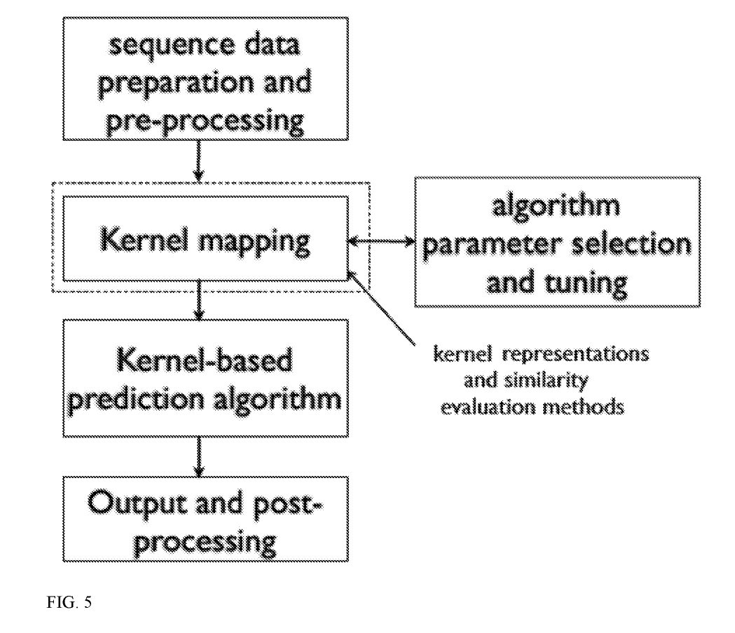

FIG. 2 shows an exemplary peptide prediction process. FIGS. 3 and 4A-4C show exemplary peptide descriptor sequence representations while FIG. 5 shows the placement of the computational method in the machine learning pipeline for training and prediction.

The method of computing the degree-of-similarity (kernel) between peptides for training (Step 2 in FIG. 2) or prediction (Step 3) using kernel functions based on descriptor sequence representations of peptides.

As shown in FIG. 3, the flow of MHC-peptide prediction model construction is as follows:
1. Using the reference peptide-allele database with measurements of peptide binding activities (quantitative or qualitative), form a training set by assigning each peptide to the class “Binding” (B) or “Not-binding” (NB) (or multiple binding classes defining various intensities of binding activities) according to the reference binding strength (quantitative or qualitative measurements of binding activity) of the corresponding peptide. This is Step 1.
2. Appropriately defined kernel function K(•,•) is then applied to pairs of peptides in the training set (Step 2). Kernel function K(•,•) is defined such that pairs of similar peptides Xᵢ, Xⱼ should have small differences in their corresponding high dimensional feature expansions Φ(Xᵢ) and Φ(Xⱼ), thus differentiating between binding and non-binding peptide instances. The kernel functions on peptides will be described in detail below.
3. Using machine learning algorithm and kernel function output values for peptides in the training set, a model that differentiates instances of binding peptides from instances of non-binding peptides (Step 3) is constructed. The trained model when applied to the unlabeled peptide sequence X produces a prediction value f(X), which suggests whether the peptide would bind (and to what degree) to the target MHC molecule.

The design of peptide representations and corresponding kernel functions used in Steps 2 and 3 is detailed next.

As detailed below, given amino acid sequences of test peptides in question and a set of representative peptides with binary binding strengths for the MHC molecule of interest, we use a nonlinear high-order machine learning method called high-order Kernel SVM to efficiently predict peptide-MHC binding. The method covers identification of MHC-binding, naturally processed and presented (NPP), and immunogenic peptides (T-cell epitopes).

In order for the peptides to bind to a particular MHC allele (i.e., fit their peptide-binding groove), the sequences of these binding peptides should be approximately superimposable: contain similar (in some sense, e.g., in the sense of the physicochemical descriptors) amino-acids or strings of amino acids (k-mers) at approximately the same positions along the peptide chain.

It is then natural to model peptide sequences X=x₁, x₂, . . . , x_{|X|}, xᵢεΣ (i.e., sequences of amino acid residues) as a sequences of descriptor vectors d₁, . . . , dₙ encoding positions/relevant properties of amino acids observed along the peptide chain.

Then, the sequence of the descriptors corresponding to the peptide X=x₁, x₂, . . . , x_{|X|}, xᵢεΣ can be modeled as an attributed set of descriptors corresponding to different positions (or groups of positions) in the peptide and amino acids or strings of amino acids occupying these positions:

X_{A}={(pᵢ,dᵢ)}ᵢ₌₁ⁿ

where pᵢ is the coordinate (position) or a set (vector) of coordinates and dᵢ is the descriptor vector associated with the pᵢ, with n indicating the cardinality of the attributed set description X_{A} of peptide X. The cardinality of the description X_{A} corresponds to the length of the peptide (i.e., the number of positions) or, in general, to the number of unique descriptors in the descriptor sequence representation. A unified descriptor sequence representation of the peptides as a sequence of descriptor vectors is used to derive attributed set descriptions X_{A}.

While the descriptor vectors in general may be of unequal length, in the matrix form (equal-sized vectors) of this representation (“feature-spatial-position matrix”), the rows are indexed by features (e.g., individual amino acids, strings of amino acids, k-mers, physicochemical properties, peptide-MHC interaction features, etc), while the columns correspond to their spatial positions (coordinates). This is illustrated in FIG. 3.

In this descriptor sequence representation, each position in the peptide is described by a feature vector, with features derived from the amino acid occupying this position/or from a set of amino acids (e.g., a k-mer starting at this position or a window of amino acids centered at this position) and/or amino acids present in the MHC protein molecule and interacting with the amino acids in the peptide.

We define three types of basic descriptors/feature vectors used to construct “feature-position” peptide representations: binary, real-valued, and discrete. These basic descriptors are also used by the kernel functions to measure similarity between individual positions, amino acids, or strings of amino acids.

The purpose of a descriptor is to capture relevant information (e.g., physicochemical properties) that can be used by the kernel functions to differentiate peptides (binding, non-binding, immunogenic, etc).

A simple binary descriptor of an amino acid is a binary indicator vector with zeros at all positions except for one position corresponding to the amino acid which is set to one. An example of the binary matrix representation of the peptide is given in FIG. 4A.

A real-valued descriptor of an amino acid is a quantitative descriptor encoding (1) relevant properties of amino acids, e.g., their physicochemical properties, and/or (2) interaction features (such as binding energy) between the amino acids in the peptide and in the MHC molecule. An example of the real-valued descriptor sequence representation of a peptide using 5-dim physicochemical amino acid descriptors is given in FIG. 4B.

A discrete (or discretized) descriptor of an amino acid or strings of amino acid (k-mer) can, for instance, encode a set of “similar” amino acids or a set of “similar” k-mers, where the set of similar k-mers can be defined as the set of k-mer at a small Hamming distance or with a small substitution or alignment-based distance. Another example of such descriptor is a binary Hamming encoding of amino acids or k-mers. FIG. 4c shows one such example of a discrete encoding of a peptide.

We define kernel functions for peptides based on peptide descriptor sequence representations (such as in FIG. 4). The kernel functions for peptide sequences X and Y have the following general form:

$$\begin{matrix}K ( X , Y ) = K ( M ( X ) , M ( Y ) ) \\ = K ( {X}_{A} , {Y}_{A} ) \\ = {\sum }_{{i}_{X}} {\sum }_{{j}_{Y}} {k}_{p} ( {p}_{{i}_{Y}}^{X} , {p}_{{j}_{Y}}^{Y} ) {k}_{d} ( {d}_{{i}_{X}}^{X} , {d}_{{j}_{Y}}^{Y} )\end{matrix}$$

where M(•) is a descriptor sequence (e.g., spatial feature matrix) representation of a peptide, X_{A} (Y_{A}) is an attributed set corresponding to M(X) (M(Y)), k_{d} (•,•), kₚ(•,•), are kernel functions on descriptors and context/positions, respectively, and i_{X}, i_{Y} index elements of the attributed sets X_{A}, Y_{A}.

The kernel function (Eq. 9) captures high-order interactions between amino acids/positions by considering essentially all possible products of features encoded in descriptors d of two or more positions. The feature map corresponding to this kernel is composed of individual feature maps capturing interactions between particular combinations of the positions. The interaction maps between different positions pₐ and p_{b} are weighted by the position/context kernel function kₚ(Pₐ,P_{b})

A number of kernel functions for descriptor sequence (e.g., matrix) forms M(•) is described below.

Kernel Functions for Descriptor Sequences

Exact-Position (Singleton) Kernel Function

Using an appropriate kernel function k_{d(•,•)} on the descriptors dᵢ, with the Kronecker delta kernel function on the coordinates pᵢ=i, the exact-position kernel function on peptides X and Y with descriptor-position matrix representation is defined as

$$K ( X , Y ) = {\sum }_{i = 1}^{i = {n}_{X}} {\sum }_{j = 1}^{j = {n}_{Y}} δ ( i , j ) {k}_{d} ( {d}_{i}^{X} , {d}_{j}^{Y} ) \qquad ( EQ . KEP )$$

This kernel function computes similarity between peptides X and Y by comparing descriptors with the same coordinates in both peptides.

Descriptor-Position-Set Kernel Function

Using binary, real-valued, or discrete descriptors dᵢ and defining pᵢ to be a set of coordinates associated with each unique descriptor, a position-set kernel is defined as

$$K ( X , Y ) = {\sum }_{{i}_{X}} {\sum }_{{j}_{Y}} {k}_{p} ( {p}_{{i}_{Y}}^{X} , {p}_{{j}_{Y}}^{Y} ) {k}_{d} ( {d}_{{i}_{X}}^{X} , {d}_{{j}_{Y}}^{Y} ) \qquad ( EQ . KDPS )$$

where kₚ (•,•) and k_{d} (•,•) are appropriate kernel functions on the sets of coordinates/positions and on the descriptors, and i_{X} and i_{Y} index elements of attributed sets X_{A} and Y_{A}. This kernel function computes similarity over features and their respective positional distributions.

Depending on the choice of the descriptors and the resulting descriptor-position matrix, the position-set kernel function implements Hamming-distance based (using discrete k-mer mutational neighborhood descriptors), or non-Hamming (general) comparison between strings of amino acids in the peptides.

For instance, Hamming-based mismatch kernel between amino acid strings (k-mers) can be obtained using linear kernel function k_{d} (•,•)=(d_{α},d_{β}) with descriptors d_{α}=(d_{α}(β))_{βεΣ,}_{^{k}} for amino acid string α,|α|=k defined as

$${d}_{α} ( β ) = \{ \begin{matrix}1 , & ifh ( α , β ) \leq m \\ 0 , & otherwise\end{matrix}$$

where h(•,•) is a Hamming distance between amino acid strings, m is the maximum number of allowed mismatches.

Context Kernel Function

Using binary descriptors dᵢ for each position i, dᵢ(j)=1 if j=Xᵢ and dᵢ(j)=0, otherwise, we form the context descriptor cᵢ for each coordinate i as

$${c}_{i} = {\sum }_{j = i - {w}_{L}}^{j = i + {w}_{R}} w ( i - j ) {d}_{j} \qquad ( EQ . CONTEXT )$$

where the weighting function w(i−j) quantifies contribution of the neighboring positions j according to their distance from i. The weighting function w(•), for instance, can be defined as follows

$$w ( i - j ) = \frac{1}{{\vert i - j \vert}^{α}} + β$$

with (α,β)-parametrization, where α describes the decay rate and β is a constant added to all weights. Using β>0 effectively takes into account even distant neighbors when forming the context descriptor c.

The kernel between peptides is then defined as

$$K ( X , Y ) = {\sum }_{{i}_{X}} {\sum }_{{j}_{Y}} δ ( {i}_{X} , {j}_{Y} ) {k}_{c} ( {c}_{i}^{X} , {c}_{j}^{y} ) \qquad ( EQ . KCONTEXT )$$

where k_{c}(c₁,c₂) is an appropriate kernel function on the context descriptors.

The kernel function k_{c} (•,•) on the context descriptors can be defined as an inner product

k_{c}(c₁,c₂)=<c₁,c₂>

or, in general, as similarity-transformed tensor product (i.e. Frobenius product between the similarity matrix and the tensor product of the context descriptors)

k_{c}(c₁,c₂)=tr((c₁\textcircled{x}c₂)S)

where S is an appropriate similarity matrix for elements of the context descriptors.

The similarity matrix S can be defined according to AA similarity matrices (e.g., BLOSUM of AAindex) by using these matrices to compute entries of S, for example as S_{i,j}=<AAᵢ,AAⱼ> or exp(−γd(AAᵢ−AAⱼ)), where AAᵢ is the ith row of the AA similarity matrix.

Property Kernel.

As the importance of various attributes for peptide classification varies, the similarity computation for two peptides X and Y can be expanded by individually measuring similarity for each attribute a=1, . . . , P along peptide chains xₐ¹, xₐ², . . . , xₐⁿ, yₐ¹, yₐ², . . . , yₐⁿ, instead of using vector-based measure of similarity (e.g, Euclidean distance Σₐ₌₁^{p}(xₐⁱ−yₐ^{j})²) between positions in the peptide chain.

To more accurately model similarities between peptides represented in descriptor sequence form (i.e. as a sequence of vectors of physicochemical amino acid attributes and/or peptide-MHC residue interaction features), sequences of each attribute values can be compared along the peptide chain with peptide similarity defined as cumulative similarity across these attributes.

We then define a property kernel to be a dot-product between vectors of individual property similarity scores

K(X,Y)=<k₁(X,Y),k₂(X,Y), . . . ,kₚ(X,Y),k₁(X,Y),k₂(X,Y), . . . ,kₚ(x,y)) (EQ.KPROP)

where

kₐ(X,Y), a=1, . . . , P is a similarity score for attribute a=1, . . . , P, e.g., one of the descriptor-sequence kernel described above.

The individual scores kₐ(X,Y) capture similarity of peptides X and Y with respect to the corresponding attribute/property a along the peptide chain. The dot-product between vectors of individual scores captures overall similarity between peptides X and Y across properties a=1, . . . , P.

Kernel Functions for Descriptors and Position Distributions

Position Kernels

(α,β)-kernel between sets of positions. Kernel functions kₚ(•,•) on position sets pᵢ and pⱼ are defined as a set kernel

$${k}_{p} ( {p}_{i} , {p}_{j} ) = {\sum }_{i ∈ {p}_{i}} {\sum }_{j ∈ {p}_{j}} k ( i , j \vert α , β )$$

$$where$$

$$k ( i , j \vert α , β ) = \frac{1}{{\vert i - j \vert}^{α}} + β = exp ( - α log ( \vert i - j \vert ) ) + β$$

is a kernel function on pairs of position coordinates (i,j).

The position set kernel function above assigns weights to interactions between positions (i,j) according to k(i,j|α,β).

RBF-kernel between sets of positions. Similarly to (α,β)-kernel above, kernel function kₚ(•,•) between position sets can be defined using RBF kernel as

$${k}_{p} ( {p}_{i} , {p}_{j} ) = {\sum }_{i ∈ {p}_{i}} {\sum }_{j ∈ {p}_{j}} exp ( - {{γ}_{p} ( i - j )}^{2} )$$

Descriptor Kernels

The descriptor kernel function (e.g., RBF or polynomial, EQ.FIX) between two descriptors dᵢ=(d₁ⁱ, d₂ⁱ, . . . , d_{R}ⁱ) and dⱼ=(d₁^{j}, d₂^{j}, . . . , d_{R}^{j}) induces high-order (i.e. products-of-features) interaction features (such as dᵢ_{₁}, dᵢ_{₂}, . . . , dᵢ_{ₚ} for polynomial of degree p) between positions/attributes.

Using real-valued descriptors (e.g., vectors of physicochemical attributes), with RBF or polynomial kernel function on descriptors, the k_{d}(d_{α},d_{β}) is defined as

exp(−γ_{d}∥d_{α}−d_{β}∥)

where γ_{d} is an appropriately chosen weight parameter, or

(<d_{α},d_{β}>+c)^{p}

where p is the degree (interaction order) parameter and c is a parameter controlling contribution of the lower order terms.

Non-Linear Extensions

For a kernel K(•,•) its non-linear polynomial extension is defined as

K_{poly}(X,Y|p,c)=(K(X,Y)+c)^{p}

where p is the degree of the polynomial and c is the constant weighting contributions of lower order terms with respect to higher order terms. To capture higher-order interactions between features describing the peptide sequence, a polynomial expansion of the first-order feature set

x=(x₁,x₂, . . . ,xₙ),

e.g., by adding second-order terms

x₂=(x₁,x₂, . . . ,xₙ,x₁x₂,x₁x₃, . . . ,x₁xₙ,x₂x₃,x₂x₄, . . . ,x₂xₙ, . . . ,xₙ−1xₙ)

can be used. In general, the inner-product (xₚ,yₚ) between two expanded feature sets xₚ and yₚ with p-order terms can then be computed (approximately) as

((x,y)+c)^{p}

where x and y are first-order feature vectors describing peptides X and Y.

For example, using binary descriptors dᵢ for each position i, p-order interactions between peptide positions can be captured with the following polynomial kernel

((d_{X}d_{Y})+c)^{p}

where d_{X}=d₁d₂ . . . d_{nX} is a peptide descriptor vector (obtained by joining descriptor vectors over all positions in the descriptor sequence matrix form (FIG. 4A).

FIG. 5 shows the placement of the computational method in the machine learning pipeline for training and prediction. The design of the kernel functions here is such that it constructs descriptor sequence (e.g., spatial feature-context matrix) representations and computes the degree-of-similarity values between peptides based on both the feature similarity (e.g., similarity of individual amino acids, strings of amino acids, or peptide-MHC interactions) and the similarity of the context (e.g., feature location/coordinate, or a set of neighboring features such as amino acids, peptide-MHC residue interaction features, etc) in which these features occur. Using both feature and context similarities, the method models the key aspects in peptide-MHC binding: high-order interactions between positions/amino acid residues/MHC molecule and their physicochemical properties.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for binding recognition, comprising:
receiving input peptide sequence;
generating a descriptor sequence representation of the input peptide sequence;
applying a convolutional attributed set representation to determine a kernel between peptides, wherein the kernel considers a similarity of individual amino acids or string of amino acids and a similarity of a context including location or coordinate, or a set of neighboring amino acids, or peptide-MHC amino acid contact residues to compute the degree-of-similarity value between peptides; and
applying one or more prediction models including qualitative binding models or quantitative binding affinity models to determine peptide-MHC interaction.

2. The method of claim 1, comprising applying an MHC-peptide interaction model to the matrix representation.

3. The method of claim 1, comprising applying MHC, source protein sequence, and structural information.

4. The method of claim 1, comprising designing a kernel functions are applied to peptides during training to estimate a set of predictor parameters, and wherein the kernel functions compute the prediction values for unlabeled peptides.

5. The method of claim 1, wherein the kernel functions determine similarity between peptides using descriptor sequence representation of the peptides.

6. The method of claim 1, wherein the kernel contains specialized kernel functions including position-set, context, and property kernel functions for peptide binding and T-cell epitope prediction.

7. The method of claim 1, comprising determining a degree-of-similarity (kernel) between peptides for training or prediction using kernel functions based on descriptor sequence representations of peptides.

8. The method of claim 1, comprising using a reference peptide-allele database with measurements of peptide binding activities to form a training set by assigning each peptide to a class of “Binding” (B) or “Not-binding” (NB) based on a reference binding strength for a corresponding peptide.

9. The method of claim 8, comprising generating a kernel function K(•,•) and applying to pairs of peptides in the training set.

10. The method of claim 8, comprising generating Kernel function K (•,•) such that pairs of similar peptides Xᵢ, Xⱼ have small differences in corresponding high dimensional feature expansions Φ(Xᵢ) and Φ(Xⱼ), and differentiating between binding and non-binding peptide instances.

11. The method of claim 8, comprising applying machine learning and kernel function output values for peptides in the training set to construct a model that differentiates instances of binding peptides from instances of non-binding peptides.

12. The method of claim 11, comprising performing parameter selection and tuning with the kernel function.

13. The method of claim 8, comprising applying a trained model to an unlabeled peptide sequence X and to generate a prediction value f(X) on the degree of peptide binding to a target MHC molecule.

14. The method of claim 1, comprising generating kernel functions for peptide sequences X and Y have the following general form:
$$\begin{matrix}K ( X , Y ) = K ( M ( X ) , M ( Y ) ) \\ = K ( {X}_{A} , {Y}_{A} ) \\ = {\sum }_{{i}_{X}} {\sum }_{{j}_{Y}} {k}_{p} ( {p}_{{i}_{Y}}^{X} , {p}_{{j}_{Y}}^{Y} ) {k}_{d} ( {d}_{{i}_{X}}^{X} , {d}_{{j}_{Y}}^{Y} )\end{matrix}$$
where M(•) is a descriptor sequence (e.g., spatial feature matrix) representation of a peptide, X_{A}(Y_{A}) is an attributed set corresponding to M(X) (M(Y)), k_{d}(•,•), kₚ(•,•), are kernel functions on descriptors and context/positions, respectively, and i_{X}, i_{Y} index elements of the attributed sets X_{A}, Y_{A}.

15. The method of claim 1, comprising generating kernel function k_{d(•,•)} on descriptors dᵢ, with a Kronecker delta kernel function on coordinates pᵢ=i, wherein an exact-position kernel function on peptides X and Y with descriptor-position matrix representation is defined as
$$K ( X , Y ) = {\sum }_{i = 1}^{i = {n}_{X}} {\sum }_{j = 1}^{j = {n}_{Y}} δ ( i , j ) {k}_{d} ( {d}_{i}^{X} , {d}_{j}^{Y} ) .$$

16. The method of claim 1, wherein binary descriptors dᵢ for each position i, dᵢ(j)=1 if j=Xᵢ and dᵢ(j)=0, otherwise, forming acontext descriptor c₁ for each coordinate i as
$${c}_{i} = {\sum }_{j = i - {w}_{L}}^{j = i + {w}_{R}} w ( i - j ) {d}_{j}$$
where weighting function w(i−j) quantifies contribution of neighboring positions j according to their distance from i.

17. The method of claim 1, comprising generating kernel between peptides as
$$K ( X , Y ) = {\sum }_{{i}_{X}} {\sum }_{{j}_{Y}} δ ( {i}_{X} , {j}_{Y} ) {k}_{c} ( {c}_{i}^{X} , {c}_{j}^{y} )$$
where k_{c}(c₁,c₂) is an appropriate kernel function on the context descriptors.

18. The method of claim 1, comprising modelling similarities between peptides represented in descriptor sequence form as a sequence of vectors of physicochemical amino acid attributes or peptide-MHC residue interaction features, and comparing sequences of each attribute values along the peptide chain with peptide similarity defined as cumulative similarity across attributes.

19. The method of claim 18, comprising generating a property kernel as a dot-product between vectors of individual property similarity scores
K(X,Y)=<k₁(X,Y),k₂(X,Y), . . . ,kₚ(X,Y),k₁(X,Y),k₂(X,Y), . . . ,kₚ(x,y)>
where
kₐ(X,Y),a=1, . . . ,P

20. The method of claim 1, comprising generating specialized kernel functions for peptide binding and T-cell epitope prediction.
